(19) United States
(12) Patent Application Publication
(10) Pub. No.: US 2009/0019012 A1
(43) Pub. Date: Jan. 15, 2009

(54) DIRECTED SEARCH METHOD AND APPARATUS

(75) Inventor: Nicholas William Dawes, Ottawa (CA)

Correspondence Address: EATON PEABODY PATENT GROUP, LLC, P.O. BOX 5249, 77 Sewall Street, Suite 3000, AUGUSTA, ME, 04332-5249, US

(73) Assignee: LOOKNOW LTD, Ottawa (CA)

(21) Appl. No.: 12/176,673

(22) Filed: Jul. 21, 2008

Related U.S. Application Data
(63) Continuation-in-part of application No. 11/566,361, filed on Dec. 4, 2006.
(60) Provisional application No. 60/971,179, filed on Sep. 10, 2007.
(60) Provisional application No. 60/863,178, filed on Oct. 27, 2006.

(51) Int. Cl. G06F 7/06; G06F 17/30

(52) U.S. Cl. 707/3; 707/E17.014

(57) ABSTRACT

A method and apparatus for directing an internet search via a web browser using predetermined search criteria such as, but not limited to, predetermined criteria in the form of a searching requirement including the geographic location of the user (e.g., town or city), health-related search results, or any similar criteria that may be desirable to create a predetermined grouping of information.

### CROSS-REFERENCE TO RELATED APPLICATIONS

The present invention claims priority from U.S. Provisional Patent Application Ser. No. 60/971,179 filed on Sep. 10, 2007 and is a continuation-in-part of U.S. patent application Ser. No. 11/566,361 filed on Dec. 4, 2006 which claims priority from U.S. Provisional Patent Application Ser. No. 60/863,178 filed on Oct. 27, 2006.

### FIELD OF THE INVENTION

The present invention relates generally to database searching. More particularly, the present invention relates to a mechanism and method that directs an internet search via a web browser using predetermined search criteria.

### BACKGROUND OF THE INVENTION

Within the art of internet-based searching, there are many different browser mechanisms available to computer users. One such mechanism includes analyzing stored information and answering questions based upon such stored information as discussed within U.S. patent application Ser. No. 11/566,361 filed on Dec. 4, 2006 and titled “Method and Apparatus for Reading Documents and Answering Questions Using Material From These Documents” the contents of which are herein incorporated by reference in their entirety. Such users of such mechanisms often want to find results local to their town or city. For example, a user might want to look for restaurants in their town or city. Although some search engines take the user's localization information into account, prior attempts for a directed search for results within a town or city has previously been difficult and unsatisfactory. Sometimes web sites have been set up trying to capture everything about a city as a repository of static information (e.g., virtual telephone directories). However, such web sites are invariably incomplete and out of date. Oftentimes, there are a vast number of relevant sources of results for a town or city, and each need to be searched for the specific query the user has in mind. This results in a complicated and time consuming search experience for the user.

It is, therefore, desirable to provide a mechanism and method that provides a cost-effective and fast solution to offer directed searches to a computer user.

### SUMMARY OF THE INVENTION

It is an object of the present invention to obviate or mitigate at least one disadvantage of previous internet search methods. The present invention includes a mechanism and method that directs an internet search via a web browser using predetermined search criteria. Such criteria is preferably, but not limited to, predetermined criteria in the form of a searching requirement including the geographic location of the user (e.g., town or city), health-related search results, or any similar criteria that may be desirable to create a predetermined grouping of information.

The present invention further includes a method for directing a search query in an internet-based environment including: labeling a local search control button with a city corresponding to the user; and labeling a search execution button to describe a present mode of search being executed.

Still further, the present invention includes an apparatus embodied within a computer readable medium for directing a search query in an internet-based environment, the apparatus including: first executable software instructions for labeling a local search control button with a city corresponding to the user, and second executable software instructions for labeling a search execution button to describe a present mode of search being executed.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a basic screenshot of the web browser mechanism in accordance with the present invention.

FIG. 2 is a web-search screenshot of the web browser mechanism in accordance with the present invention.

FIG. 3 is a local-search screenshot of the web browser mechanism in accordance with the present invention.

FIG. 4 is a health-search screenshot of the web browser mechanism in accordance with the present invention.

### DETAILED DESCRIPTION

Generally, the present invention provides a mechanism and method directing an internet search via a web browser using predetermined search criteria such as, but not limited to, predetermined criteria in the form of a searching requirement including the geographic location of the user (e.g., town or city), health-related search results, or any similar criteria that may be desirable to create a predetermined grouping of information.

The present invention described herein provides a useful and extremely satisfactory solution to the problem of providing accurate results to directed searching in a web-based environment. In such instances, computer users often execute search queries in order to find results local to their town or city. For example, a user is often interested in locating restaurants in their town or city. The present invention uses the user's localization information in a unique manner so as to quickly and easily provide directed search for results within a town or city.

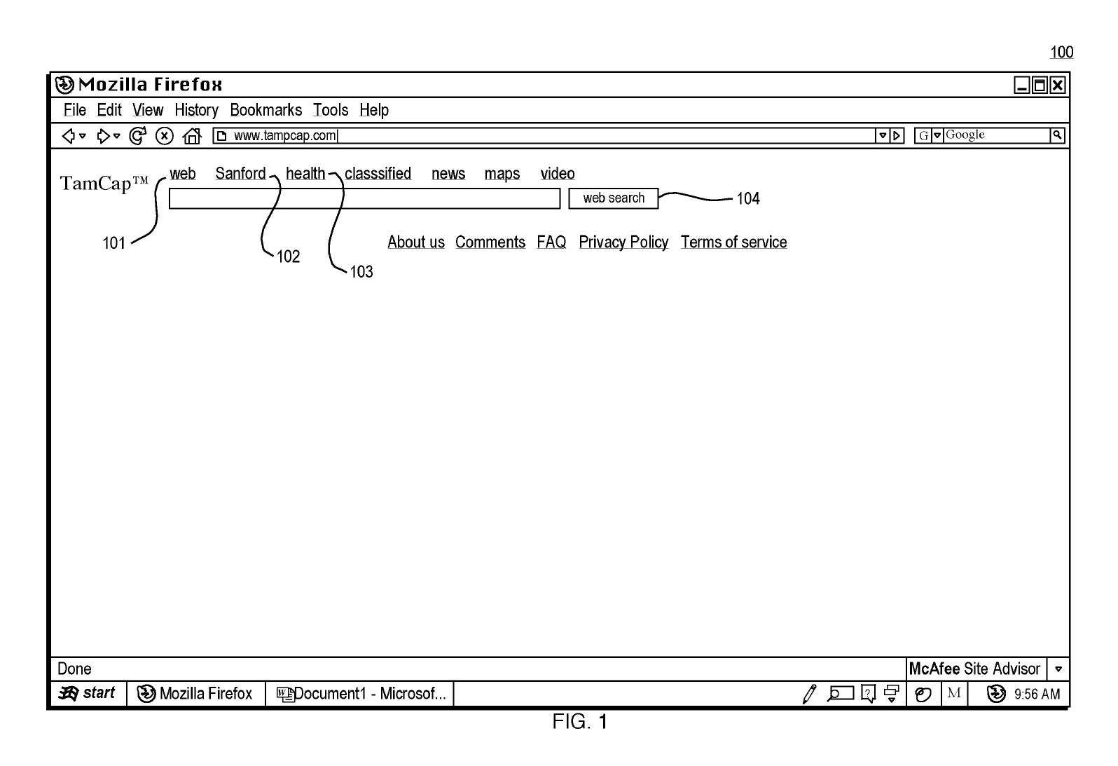

Specifically, users operate the present invention in the form of a search engine from an HTML (Hypertext Markup Language) search control page. One of ordinary skill in the art would therefore recognize that the present invention is therefore embodied with a computer readable medium in the form of executable software instructions (i.e., software code). The search control page is loaded by the user from a remote web server across the internet in a manner known to those skilled in the art of networking. Such search control page is shown in FIG. 1 as screen 100 having a “web” button for standard searching of all web-based resources, a local button 102 (shown as “Sanford” which represents the town of Sanford, Me.) for location-based searching of only “Sanford”-related information, and a “health” button 103 for health-related searching or all web-based resources. Although these buttons include web search, local search and health search choices, it should be readily understood that the present invention may include other predetermined criteria to direct the user's search results.

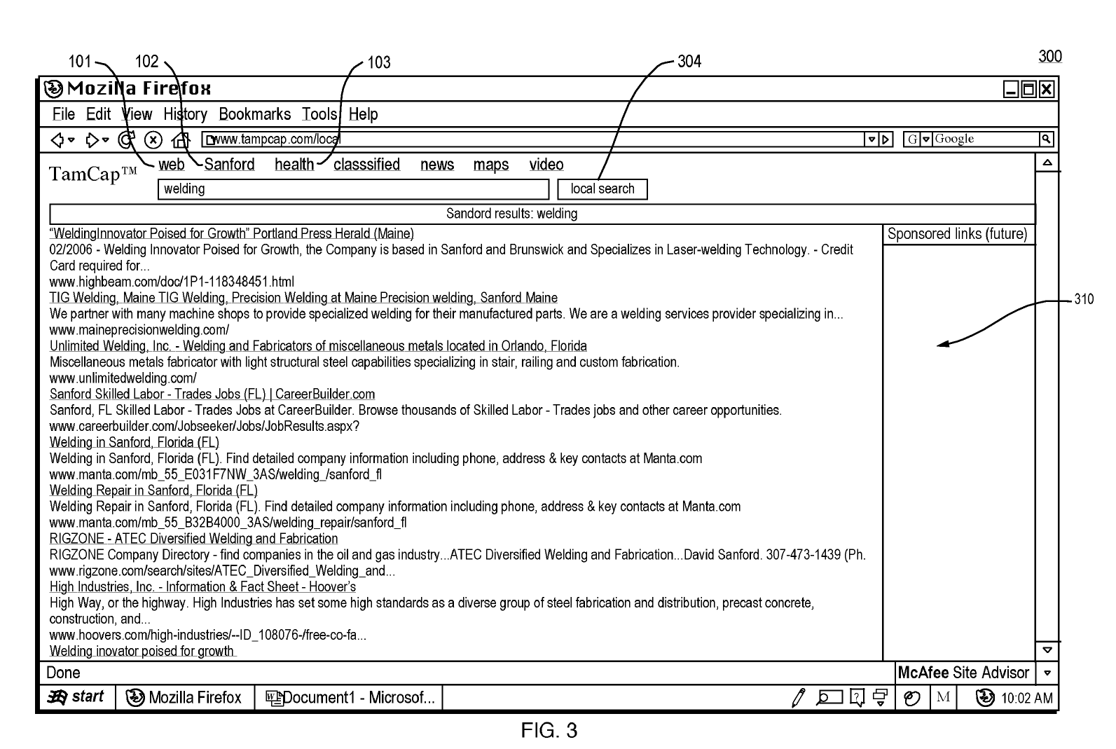

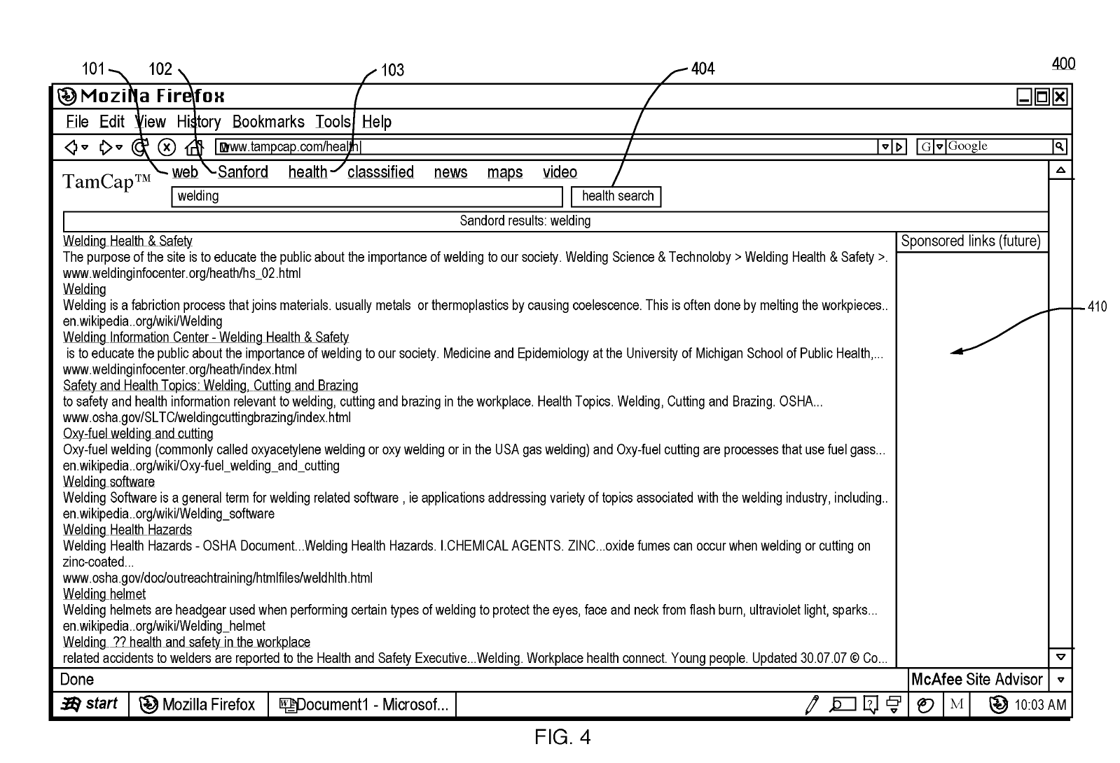

As mentioned, the predetermined search criteria in the form of buttons 101, 102, and 103 include the web search and health search which are labeled “web” and “health” respectively. However, the local search is labeled with the city for that user. In the examples shown in the figures, such local search is for Sanford, Me. The method for determining the user's city is discussed further below as is execution of a “Local Search” with further regard to FIG. 3. When the user selects “Sanford” 102 (i.e., the user customized label for local search) the label on the search execution button shows “local search” (see element 304). Thus, it should be readily apparent that if the user's city is Sanford, then the local search button 102 is labeled “Sanford”, not “local” while the search execution button 304 (as seen in FIG. 3) is labeled “local search.” Should the user select “health”, the search execution button 404 (as seen in FIG. 4) on the search button shows “health search”. Should the user type in a query and press the search button, the appropriate mode of search indicated by the given active search execution button will be carried out. It should be noted that the given mode of search may be indicated as shown in the figures or, alternatively, in some other way without straying from the intended scope of the present invention.

The method for determining the user's location (e.g., city or town) will now be discussed. First, the user's internet service provider (ISP) is generally an available piece of information. It should be understood that a modern web server and a standard software method may be therefore used to determine the user's ISP. Once the ISP is identified, the city, region and country for the user's ISP are then obtained by way of looking up such information in a copy of a commercial database of ISPs. It should be understood that the use of such a commercial database is well understood in the art of computer databases. Such database can be either within the server of the present invention or hosted by another server. Once the ISP location information is found, then such information is associated with the user in order to customize the local search button to that given location.

A useful feature of the present invention provides that the user may change the location as indicated by the local search button. As the user's city is shown on the search control page, should the database be in error and provide the wrong city, the user can use a “Change city” control (not shown) to let the present inventive method and mechanism know then and in the future that the location of the user's computer is in the city that user can then specify. For example, suppose the database states that a particular IP is in New York City, when it is really in Hoboken, N.J. In such instance, the user will see the word “New York City” on the page and can then alter this to be “Hoboken”. After such a setting, the web server of the present invention will detect, by a cookie, that this user is really in Hoboken.

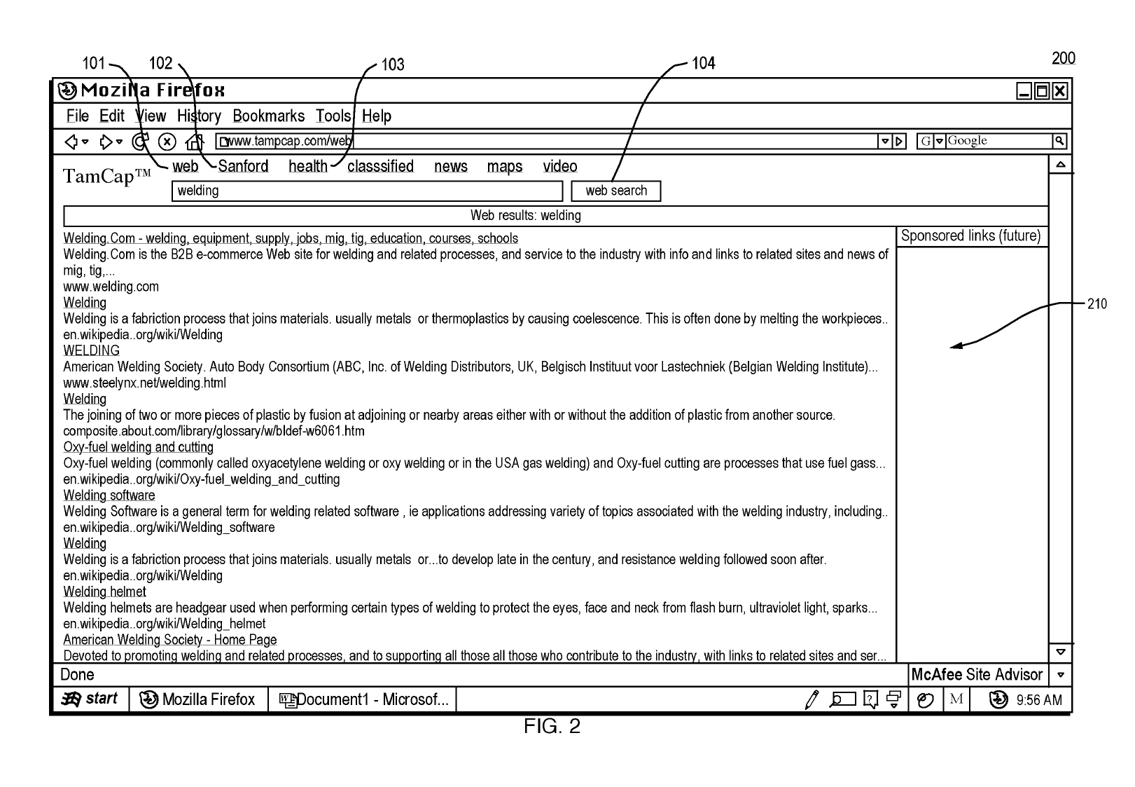

With regard to FIG. 2, a standard web search is shown for the query “welding”. In such instance, the search results 210 are returned without any regard to the user's specific location. With regard to FIG. 3, the user is shown to have pressed the “Sanford” button 102 which is shown to have changed the search execution button to “local search” 304. Here, the method for a local search will now be discussed. A local search is like a standard search, but considers the context of the user's city. For the example as shown, the search query “welding” is again used though in a local search mode. In such instance, the search results 310 are returned with information related inasmuch as possible, to the location of the user. In other words, suppose a user sitting in Ottawa, Ontario has clicked on the location button labeled “Ottawa” to choose local search for “Ottawa”. Then he types in the query “restaurants” and presses the “local search” button. Such a search will therefore immediately return restaurants in Ottawa.

Although one important aspect of the present invention as discussed above has focused on the user's city, it should be understood that the region and country for that city may also be considered in the search, although these may or may not be indicated on the search control page. In this way local search results for a user in Ottawa, Ontario, Canada are not the same as those for a user in Ottawa, Kans., USA. It should therefore be apparent that the present invention results in a customization of the local search button which advantageously reduces the number of keystrokes needed to perform a local search and so improves the efficiency of searching. Moreover, the presentation of the local city name to the user within the web interface makes it clear what local search is being done, and does so without extra user input.

With regard to FIG. 4, a health-based web search is shown for the query “welding”. In such instance, the search results 410 are returned without any regard to the user's specific location. In such instance, the search results 410 are returned with information related inasmuch as possible, to the search field of health. Such health-based web search is considered a different search mode. As well, further alternative search modes are possible without straying from the intended scope of the present invention. The explicit separation of a local search mode from other search modes (e.g., health-based search) is a unique and advantageous improvement over known searching methods.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for directing a search query in an internet-based environment comprising:
a. labeling a local search control button with a city corresponding to said user; and
b. labeling a search execution button to describe a present mode of search being executed.

2. The method as claimed in claim 1 wherein region information corresponding said user is used to select only search results specific to said city corresponding to said user.

3. The method as claimed in claim 1 wherein country information corresponding to said user is used to select only search results specific to said city corresponding to said user.

4. The method as claimed in claim 1 wherein region and country information corresponding to said user is used to select only search results specific to said city corresponding to said user.

5. The method as claimed in claim 1, wherein said labeling of said local search control button occurs on an initial control page shown to said user and on all subsequent pages.

6. The method as claimed in claim 5, wherein said labeling of said local search control button occurs with search results.

7. The method as claimed in claim 5, wherein said labeling of said local search control button occurs without search results.

8. The method as claimed in claims 5, wherein said labeling of said local search control includes a label corresponding to a label group consisting of web search, local search, and health search.

9. The method as claimed in claim 8, wherein said local search label is changed to said city corresponding to said user.

10. Apparatus embodied within a computer readable medium for directing a search query in an internet-based environment, said apparatus comprising:
first executable software instructions for labeling a local search control button with a city corresponding to said user, and
second executable software instructions for labeling a search execution button to describe a present mode of search being executed.

11. The apparatus as claimed in claim 10 wherein region information corresponding said user is used by further executable software instructions to select only search results specific to said city corresponding to said user.

12. The apparatus as claimed in claim 10 wherein country information corresponding to said user is used by further executable software instructions to select only search results specific to said city corresponding to said user.

13. The apparatus as claimed in claim 10 wherein region and country information corresponding to said user is used by further executable software instructions to select only search results specific to said city corresponding to said user.

14. The apparatus as claimed in claims 10, wherein said labeling of said local search control includes a label corresponding to a label group consisting of web search, local search, and health search.

15. The apparatus as claimed in claim 10, wherein further executable software instructions are provided for changing said local search label to said city corresponding to said user.

16. The apparatus as claimed in claim 15, wherein said further executable software instructions use internet service provider information so as to change said local search label to said city corresponding to said user.

17. The apparatus as claimed in claim 15, wherein said further executable software instructions use updated location information entered by said user so as to change said local search label to said city corresponding to said user.

18. The apparatus as claimed in claim 17, wherein said further executable software instructions provides for retention of said updated location information for subsequent search queries made by said user.

19. The apparatus as claimed in claim 10, wherein said present mode of search is a local search mode.

20. The apparatus as claimed in claim 19, wherein said present mode of search is distinct from said local search mode.
